(19) United States
(12) Patent Application Publication
(10) Pub. No.: US 2022/0235775 A1
(43) Pub. Date: Jul. 28, 2022

(54) ROTATING DEVICE

(71) Applicant: MINEBEA MITSUMI Inc., Nagano (JP)

(72) Inventors: Hitoshi IWATA, Kitasaku-gun, Nagano (JP); Tsuyoshi KANO, Kitasaku-gun, Nagano (JP); Naoki OHSAWA, Kitasaku-gun, Nagano (JP); Shoma YAMANISHI, Kitasaku-gun, Nagano (JP); Toshiyuki NISHIKATA, Kitasaku-gun, Nagano (JP); Michihiro SHIMIZU, Kitasaku-gun, Nagano (JP); Yuta AMAGI, Kitasaku-gun, Nagano (JP)

(21) Appl. No.: 17/596,398

(22) PCT Filed: Jun. 12, 2020
(86) PCT No.: PCT/JP2020/023298

§ 371 Date: Dec. 9, 2021

(30) Foreign Application Priority Data
Jun. 14, 2019 (JP) 2019-111612

(51) Int. Cl. F04D 19/00; H02K 7/14

(52) U.S. Cl. CPC F04D 19/002; F04D 29/059; H02K 7/14

(57) ABSTRACT

A rotating device comprising: an axial member; a tubular rotating body rotatable in relation to the axial member; a tubular housing surrounding the rotating body; a bearing supporting the rotating body with respect to the axial member; a stator inside the rotating body; and one or a plurality of rotor blades provided to the rotating body.

### TECHNICAL FIELD

The present invention relates to a rotating device, and particularly relates to a rotating device for generating wind for the purpose of suctioning air or blowing wind.

### BACKGROUND ART

To date, various types of rotating devices generating wind for the purpose of suctioning air or blowing wind have been developed, manufactured, and used in accordance with various applications and required performance. In this context, there is a demand for improving performance such as high speed rotation and wind volume increase, which are fundamental for generating wind, and there is a demand for further size reduction of the entire device, and achieving both demands at higher levels is required.

### CITATION LIST

### Patent Literature

Patent Document 1: JP 56-100063 UM-A

### SUMMARY OF INVENTION

### Technical Problem

Accordingly, the present invention has an object of providing a rotating device capable of meeting a demand for size reduction. Furthermore, the present invention addresses a problem to provide a rotating device with excellent fundamental performance for generating wind while meeting the demand for size reduction.

### Solution to Problem

The above problems are solved by the present invention described below. Specifically, a rotating device according to the present invention includes an axial member, a tubular rotating body rotatable in relation to the axial member, a tubular housing surrounding the rotating body, a bearing supporting the rotating body with respect to the axial member, a stator inside the rotating body, and one or a plurality of rotor blades provided to the rotating body.

In the rotating device according to the present invention, at least one end part or a vicinity of the axial member may be fixed to the housing.

In the rotating device according to the present invention, a stationary blade may be provided at an inner surface of the housing, the inner surface opposing an outer surface of the rotating body.

In this case, the one or plurality of rotor blades and the stationary blade are preferably arranged side by side at a predetermined interval in the axial direction of the axial member.

The rotating device according to the present invention includes two bearings as the bearing, the two bearings being a first bearing and a second bearing, the first bearing may be disposed at one end part side of two end parts of the axial member, and the second bearing may be disposed at the other end part side of the axial member.

In this case, it is preferable that, in the axial direction of the axial member, a position of the one or plurality of rotor blades and a position of the first bearing at least partially overlap with each other, and a position of the stationary blade and a position of the second bearing at least partially overlap with each other.

Furthermore, in this case, in the axial direction of the axial member, the one or plurality of rotor blades are preferably disposed between the first bearing and the second bearing.

In this case, a preload in a direction toward one bearing of the first bearing and the second bearing may be applied to an inner peripheral ring fixed to the axial member in the other bearing.

In the rotating device according to the present invention, in the axial direction of the axial member, the one or plurality of rotor blades may be disposed at a center part of the rotating body.

In the rotating device according to the present invention, each of the one or plurality of rotor blades may include a tubular part and a plurality of blades provided at the tubular part, and the plurality of blades may be provided at the tubular part at predetermined intervals in a circumferential direction of the tubular part.

### BRIEF DESCRIPTION OF DRAWINGS

FIG. 1 is a cross-sectional view of a rotating device according to a first embodiment, being one example of the present invention.

FIG. 2 is a transparent perspective view of a rotating device according to a second embodiment, being one example of the present invention.

FIG. 3 is a transparent cross-sectional view of a cross section including an axial line x of the rotating device according to the second embodiment, being one example of the present invention.

FIG. 4 is a cross-sectional view taken along a cross section A-A in FIG. 2.

FIG. 5 is a transparent perspective view of a rotating device according to a third embodiment, being one example of the present invention.

FIG. 6 is a transparent cross-sectional view of a cross section including an axial line x of the rotating device according to the third embodiment, being one example of the present invention.

FIG. 7 is a transparent perspective view of a rotating device according to a fourth embodiment, being one example of the present invention.

FIG. 8 is a transparent cross-sectional view of a cross section including an axial line x of the rotating device according to the fourth embodiment, being one example of the present invention.

FIG. 9 is a cross-sectional view of a cross section including an axial line x of a rotating device according to a fifth embodiment, being one example of the present invention.

FIG. 10 is a cross-sectional view taken along a cross section B-B in FIG. 9.

FIG. 11 is an explanatory diagram (cross-sectional view) for explaining a flow of cooling air to the inside of a rotor of the rotating device according to the fifth embodiment, being one example of the present invention.

FIG. 12 is a cross-sectional view of a cross-section parallel to an axial line x, cut before the axial line x of a rotating device according to a sixth embodiment, being one example of the present invention.

FIG. 13 is a cross-sectional view illustrating a middle housing being extracted together with stationary blades provided at an inner periphery of the middle housing from the rotating device according to the sixth embodiment, being one example of the present invention, and cut out at a cross section including the axial line x.

### DESCRIPTION OF EMBODIMENTS

A rotating device according to embodiments of the present invention will be described below with reference to the drawings.

### First Embodiment

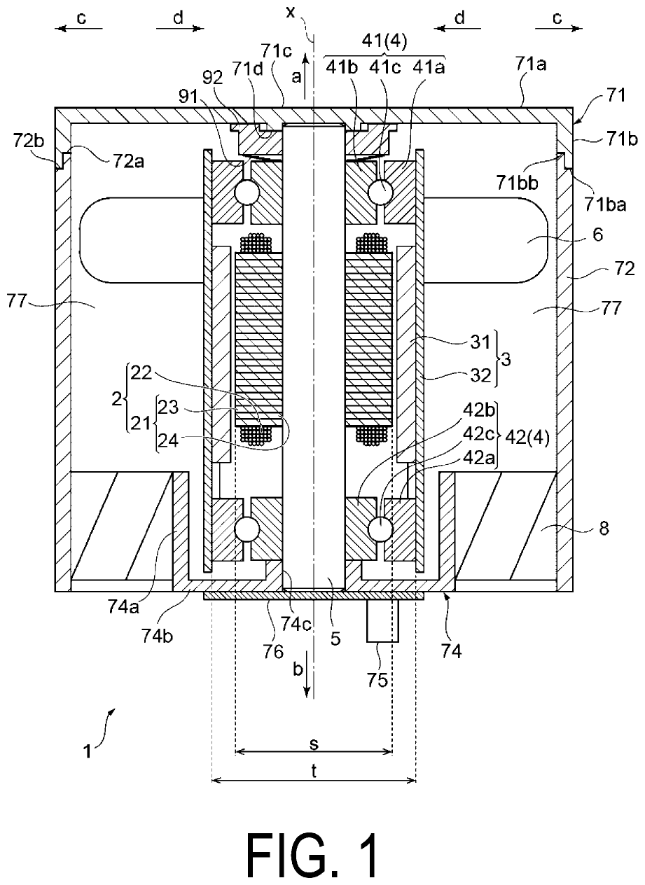

FIG. 1 is a cross-sectional view of a rotating device 1 according to a first embodiment, being one example of the present invention.

Note that in the description of the present embodiment, “upper side” and “lower side” refer to an up and down relationship in FIG. 1, and do not necessarily correspond to an up and down relationship in the gravitational direction.

In an axial line x direction (hereinafter, also referred to as “axial direction”), an arrow a direction is referred to as an upper side a, and an arrow b direction is referred to as a lower side b. In a direction perpendicular to the axial line x (hereinafter, also referred to as “radial direction”), a direction away from the axial line x (arrow c direction) is referred to as an outer peripheral side c, and a direction toward the axial line x (arrow d direction) is referred to as an inner peripheral side d. In a circumferential direction (circumferential direction viewed from the upper side a) around the rotation axial line x, a clockwise direction is referred to as a circumferential direction e, and a counterclockwise direction is referred to as a circumferential direction f. Note that the circumferential direction e and the circumferential direction f are not illustrated in FIG. 1.

In addition, in the description of the present embodiment, in the rotating device 1, a part rotating may be referred to as a “rotating side”, and a part supporting a member at the rotating side and fixed without rotating may be referred to as a “fixed side”. Since the part fixed without rotating is relatively stationary with respect to the part rotating, the part fixed without rotating may be referred to as a stationary part.

The above-described up and down relationship of the drawings, a direction such as the axial line x direction, the upper side a, the lower side b, the outer peripheral side c, the inner peripheral side d, the circumferential direction e, and the circumferential direction f, as well as descriptions representing parts such as “rotating side” and “fixed side” are similar to those in all subsequent embodiments.

The rotating device 1 according to the present embodiment includes an axial member 5, a rotor 3 that is a tubular rotating body rotatable with respect to the axial member 5, a tubular housing 7 surrounding the rotor 3, a bearing 4 supporting the rotor 3 with respect to the axial member 5, a stator 2 inside the rotor 3, a plurality of rotor blades 6 provided at the rotor 3, and stationary blades 8 provided at an inner surface of the housing 7 opposing an outer surface of the rotor 3.

The stator 2 includes a stator core 21 and a coil 22, the stator core 21 having magnetic pole parts 23 fixed to the axial member 5 and extending radially toward the outer peripheral side c with the axial member 5 as an axis, and the coil 22 being wound around the magnetic pole parts 23. The illustrated stator 2 is disposed in the housing 7 so that a gap between a second bearing 42 and the stator 2 is larger than a gap between a first bearing 41 and the stator 2.

The stator core 21 includes an annular part 24 and the plurality of magnetic pole parts 23, the annular part 24 being a laminate body formed by laminating magnetic bodies such as silicon steel plates or the like and being disposed coaxially so as to surround the axial member 5, and the plurality of magnetic pole parts 23 being formed to extend radially toward the outer peripheral side c in the radial direction from the annular part 24.

The coil 22 is wound around the plurality of magnetic pole parts 23 in the stator core 21. The stator core 21 and the coil 22 are insulated by an insulator (not illustrated) formed of an insulating material. Note that, instead of the insulator, an insulating film may be coated on a surface of the stator core 21 to insulate the stator core 21 from the coil.

The rotor 3 includes a magnet 31 and a tubular member 32, the magnet 31 opposing the magnetic pole parts 23 at the outer peripheral side c of the stator 2, and the magnet 31 being disposed at an inner peripheral surface of the tubular member 32. The tubular member 32 has a cylindrical shape centered at an axis of the axial member 5 and is in a state of surrounding the stator 2. The tubular member 32 also has a function of preventing leakage of a magnetic field from the inner side of the tubular member 32 and is formed ofa magnetic material. Note that the tubular member 32 may be formed of a non-magnetic material such as aluminum or plastic, for example, as long as there is no problem with the characteristics of the tubular member 32.

The magnet 31 is attached to the inner peripheral surface of the tubular member 32 so as to oppose the stator 2. The magnet 31 has an annular shape, and is provided with a region magnetized to the north pole and a region magnetized to the south pole alternately at a regular cycle (or at regular intervals) along a circumferential direction. The magnet 31 may be an annular integrally molded article; however, a plurality of magnets may be attached in a row to the inner peripheral surface of the tubular member 32 and arranged in a tubular shape.

The bearings 4 are disposed at two sides of the stator 2 in the axial direction of the axial member 5, and include two bearings, the two bearings being a first bearing 41 positioned at the upper side a and a second bearing 42 positioned at the lower side b. In other words, the magnet 31 and the stator 2 are positioned between the first bearing 41 and the second bearing 42 in the axial direction of the axial member 5. The first bearing 41 and the second bearing 42 are members having the same configuration (shape, structure, size, and material are the same). The first bearing 41 is described below, but the description similarly applies to the second bearing 42.

The first bearing 41 is a so-called ball bearing including an outer peripheral ring 41a, an inner peripheral ring 41b, and bearing balls 41c interposed between the outer peripheral ring 41a and the inner peripheral ring 41b. The bearing balls 41c roll between the outer peripheral ring 41a and the inner peripheral ring 41b, so that the rotational resistance of the inner peripheral ring 41b with respect to the outer peripheral ring 41a is significantly reduced. The first bearing 41 is formed of a hard metal, such as iron, or a ceramic, for example, in consideration of its function.

The inner peripheral ring 41b of the first bearing 41 is loosely fitted to the axial member 5, and then fixed by an adhesive. Thus, a gap between the inner peripheral ring 41b of the first bearing 41 and the axial member 5 is filled with the adhesive, and the inner peripheral ring 41b of the first bearing 41 is fixed with respect to the axial member 5 and serves as a stationary part together with the axial member 5. The inner peripheral ring 42b of the second bearing is fixed to the axial member 5 by press fitting, and serves as a stationary part together with the axial member 5. Here, the axial member 5 and the housing 7 are members that are stationary with respect to (relative to) the rotor 3. Thus, these are collectively referred to as a stationary member (stationary part).

The outer peripheral ring 41a of the first bearing 41 and the outer peripheral ring 42a of the second bearing 42 are fixed to the inner peripheral surfaces of both end parts of the tubular member 32. On the other hand, the inner peripheral ring 41b of the first bearing 41 and the inner peripheral ring 42b of the second bearing 42 are fixed to the outer peripheral surface of the axial member 5. As described above, the rotor 3 is configured to be rotatable about the axial line x of the axial member 5 as a center axis.

As illustrated in FIG. 1, in the present embodiment, a radial dimension t, which is the dimension of the bearing 4 (first bearing 41) in the radial direction, is larger than a radial dimension s, which is the dimension of the stator 2 in the radial direction (t>s).

The axial member 5 is formed of aluminum, for example, into a hollow state (more specifically, a cylindrical state) for weight reduction. In the present embodiment, the axial member 5 is a member at the fixed side. Since the member has a function of supporting the stator 2, the rotor 3, the bearing 4, and the rotor blades 6 with respect to the housing 7, it is necessary to have rigidity corresponding to the function.

An opening (not illustrated) is provided at the middle (intermediate part) of the axial member 5, and a lead wire (not illustrated) connected to the coil 22 is drawn from the opening into a cavity within the axial member 5, and is pulled out of the rotating device 1 from an end part opening (not illustrated) of the axial member 5.

In the rotating device 1 according to the present embodiment, the tubular member 32 is closed at both end parts by the first bearing 41 and the second bearing 42. Power needs to be supplied to the coil 22 of the stator 2 in this enclosed space.

In the rotating device 1 according to the present embodiment, the lead wire is passed through the cavity within the axial member 5, thereby electrically connecting the inside of the space enclosed by the tubular member 32, the bearing 4, and the like, to the outside of the space. Therefore, the lead wire can power the coil 22 of the stator 2 in the enclosed space.

A motor part (in other words, a part constituted by the stator 2, the rotor 3, the bearing 4, and the axial member 5; the same applies hereinafter) in the rotating device 1 configured as described above has the rotor 3 rotatable with respect to the stator 2 fixed to the axial member 5 and surrounding the stator 2, and constitutes a so-called outer rotor type brushless motor. In a typical outer rotor type brushless motor, an axial member fixed to a rotor rotates and the axial member extracts a rotational force, whereas in the rotating device 1 according to the present embodiment, the axial member 5 is a member at the fixed side, and is configured so that the rotational force is directly extracted from the rotor 3.

The housing 7 is a member having a cylindrical shape, and is formed of a plastic, a metal, or the like, for example. Although not illustrated, both ends in the axial direction of the housing 7 are openings (hereinafter, an opening at the upper side a is referred to as an “upper end opening” and an opening at the lower side b is referred to as a “lower end opening”). A space 77 communicating from the upper end opening to the lower end opening is formed as a ventilation passage between the inner peripheral surface of the housing 7 and the outer peripheral surface of the tubular member 32.

The rotor blades 6 protruding toward the inner peripheral surface of the housing 7 (toward the outer peripheral side c) are attached to the outer peripheral surface of the tubular member 32 of the rotor 3 in a region overlapping with the first bearing 41 in the axial direction (the axial line x direction) of the axial member 5. The rotor blades 6 include a plurality of blades arranged at predetermined intervals in the circumferential direction of the outer peripheral surface of the tubular member 32 and rotate along with rotation of the rotor 3, and air flow is generated by the rotation of the rotor blades 6 toward either the upper or lower direction in the space 77, depending on the rotational direction. In the rotating device 1 according to the present embodiment, the rotating device 1 is configured to be driven to rotate the rotor blades 6 in the counterclockwise circumferential direction f so that air taken in from the upper end opening is blown out from the lower end opening.

In the rotating device 1 according to the present embodiment, a position of the rotor blades 6 in the axial line x direction in the rotor 3 is biased toward the upper side a. Since the rotor blades 6 are close to the upper end opening being the air intake side, the rotating device 1 according to the present embodiment has a high air suction efficiency. On the other hand, the position of the rotor blades 6 in the axial line x direction is biased toward the upper side a, so that in order to bias a position of the center of gravity of the rotor 3 toward the upper side a accordingly, a position of the magnet 31 in the axial line x direction is also biased toward the upper side a.

In other words, the magnet 31 is disposed at a position in the axial line x direction such that a distance between the magnet 31 and the first bearing 41 is shorter than a distance between the magnet 31 and the second bearing 42. Since, by bringing the position of the magnet 31 in the axial line x direction closer to the position of the rotor blades 6 in the axial line x direction, the position of the center of gravity of the rotor 3 and the position of the rotor blades 6 in the axial line x direction are closer to each other, the rotation of the rotor 3 can be more easily stabilized. The stabilization of the rotation of the rotor 3 is expected to result in high-speed rotation of the rotor 3 and an increase in wind volume to be blown as the rotating device 1.

The housing 7 includes a tubular main body part (hereinafter, referred to as a “housing main body part”) 78 including a bottom part accommodating the motor part and the rotor blades 6, and a lid body 71 covering an upper opening of the housing main body part 78.

The lid body 71 includes a flat tubular part (hereinafter, referred to as a “lid tubular part”) 71b, a plurality of (for example, four) spoke parts (hereinafter, referred to as “lid spoke parts”) 71a from the upper end of the lid tubular part 71b toward the inner peripheral side d, and a disc part (plate part) 71c connected to the plurality of lid spoke parts 71a. A region other than the plurality of lid spoke parts 71a and the disc part 71c at the upper end of the lid body 71 forms the upper end opening.

On the other hand, the housing main body part 78 includes a tubular part (hereinafter, referred to as a “housing tubular part”) 72 having a cylindrical shape, and a donut-shaped support part (hereinafter, referred to as a lower support part) 74 connecting to an inner peripheral part of the stationary blades 8. A region other than the lower support part 74 at the lower end of the housing main body part 78 forms the lower end opening.

The lower support part 74 includes a circular bottom surface part 74b, a tubular part (hereinafter, referred to as an “outer tubular part”) 74a rising up from the outer peripheral end of the outer peripheral side c of the bottom surface part 74b to the upper side a, and a tubular part (hereinafter, referred to as an “inner tubular part”) 74c slightly rising up from the inner peripheral end of the inner peripheral side d of the bottom surface part 74b to the upper side a. Note that the circular bottom surface part 74b serves as a connecting part connecting the inner tubular part 74c to the inner peripheral part of the stationary blades 8.

The inner diameter of the inner tubular part 74c is substantially the same diameter as the end part of the axial member 5 or slightly smaller than the end part of the axial member 5, so as to be press fitted with the end part of the axial member 5. The upper end of the inner tubular part 74c is in contact with the inner peripheral ring 42b of the second bearing 42 and presses and positions the inner peripheral ring 42b of the second bearing 42.

A stage 75 supporting the housing 7 is joined to a surface at the lower side b side of the bottom surface part 74b via a joining plate 76 as another member. The stage 75 has a circular shape when viewed from the lower side, and functions as a connecting member or a support platform (foot) when the rotating device 1 is supported by or placed on another member.

The outer tubular part 74a opposes the inner peripheral surface of the housing tubular part 72 with a given interval. The stationary blades 8 are disposed between the outer tubular part 74a and the housing tubular part 72. the stationary blades 8 are disposed at a position being a region overlapping with the second bearing 42 in the axial direction (the axial line x direction) of the axial member 5.

This stationary blades 8 are members having a function of rectifying a flow of wind generated by the rotor blades 6 and directed to the lower side. The stationary blades 8 have a plate-like shape partitioning so that a plurality of flow channels are aligned parallel to the axial direction of the axial member 5, and specific examples include, for example, cylindrical plate-like shapes having different diameters with the axial line x as the center axis being arranged in an annular ring shape in the radial direction, and a shape partitioned by a plate-like shape so that a number of straight-tubes parallel to the axial direction of the axial member 5 are aligned. For the latter, a shape of holes viewed from the upper side or the lower side includes a grid shape, a honeycomb shape, a shape having circles being arranged, a shape having triangles being arranged, a shape having other polygons being arranged, and the like. As necessary, the direction of the flow channels may be inclined with respect to the axial direction of the axial member 5.

In the present embodiment, the rotor blades 6 and the stationary blades 8 are arranged side by side at a predetermined interval in the axial direction (axial line x direction) of the axial member 5. By providing the predetermined interval between the rotor blades 6 and the stationary blades 8, the flow of air is effectively rectified. Thus, a larger amount of air at high wind pressure can be discharged from the lower end opening.

When the “predetermined interval” between the rotor blades 6 and the stationary blades 8 is too small, the rectification effect is not sufficient, when it is too large, the wind pressure decreases; both of which are not preferable. The preferable value of the “predetermined interval” differs in accordance with various conditions such as the diameter of the rotor blades 6 or the stationary blades 8, the distance between the housing 7 and the rotor 3, and the rotational speed of the rotor blades 6, but roughly, the value is preferably selected from approximately a range of a length L from the root (the outer peripheral surface of the tubular member 32) of the rotor blades 6 to the tip (the end part at the outer peripheral side c) or more and 5 times of the length L (5 L) or less, and more preferably selected from approximately a range of 2 L and more and 4 L or less.

A ring-shaped rib 71d fitted to the end part of the axial member 5 is formed at a part at the lower side b side of the disc part 71c in the lid body 71. The end part of the axial member 5 can be positioned by fitting the end part of the axial member 5 to a recess at the inner side of the rib 71d. The end part of the axial member 5 can be positioned by passing the axial member 5 through a hole of a donut-shaped fixing member 92 and fixing the fixing member 92 to a part at the lower side b side of the disc part 71c in the lid body 71 so that the fixing member 92 covers the rib 71d.

A disc spring 91 being an elastic member is interposed between the lower surface of the fixing member 92 and the upper surface of the inner peripheral ring 41b of the first bearing 41. The disc spring 91 fixed in a state of being pressed from the upper side by the fixing member 92 urges the inner peripheral ring 41b of the first bearing 41 to the lower side by its elastic force. In other words, a preload in a direction toward the second bearing 42 is applied to the inner peripheral ring 41b of the first bearing 41 by the combination of the disc spring 91 and the fixing member 92.

With the preload, the inner peripheral ring 41b of the first bearing 41 can be fixed to the axial member 5 with an adhesive or the like in a state of positioning the inner peripheral ring 41b included in the first bearing 41 being loosely fitted to the axial member 5.

Note that in the present embodiment, the example of applying the preload in the direction toward the second bearing 42 to the inner peripheral ring 41b of the first bearing 41 at the upper side a is given, but the similar effects to the present embodiment are exhibited even when the configuration is reversed, in other words, the preload in the direction toward the first bearing 41 is applied to the inner peripheral ring 42b of the second bearing 42 at the lower side b.

A protruding part 71ba protruding toward the lower side b at the outer peripheral side c and a notched part 71bb cut away from an end part at the lower side b at the inner peripheral side d toward the upper side a are formed at a lower end of the lid tubular part 71b. A protruding part 72a protruding toward the upper side a at the inner peripheral side d and a notched part 72b cut away from an end part at the upper side a at the outer peripheral side c toward the lower side b are formed at an upper end of the housing tubular part 72.

The lid tubular part 71b of the lid body 71 and the housing tubular part 72 of the housing main body part 78 are connected to each other by mutually engaging a protrusion (hereinafter, referred to as a protruding part) 71ba of the lid tubular part 71b with a recess (hereinafter referred to as a notched part) 72b of the housing tubular part 72, and the protruding part 72a of the housing tubular part 72 with the notched part 71bb of the lid tubular part 71b.

As described above, in the present embodiment, the housing 7 includes the housing main body part 78 and the lid body 71 separate from each other, so that the lid body 71 is detachable from and attachable to the housing main body part 78. The rotating device 1 according to the present embodiment can be manufactured by, with the lid body 71 detached, temporarily fixing the motor part with the rotor blades 6 attached, to the inside of the housing main body part 78 and then attaching the lid body 71. The motor part is temporarily fixed to the housing main body part 78 by press fitting the end part of the axial member 5 into the inner tubular part 74c.

The method of bonding between the lid body 71 and the housing main body part 78 may be any conventionally known method such as fitting, threading, locking, screwing, clipping, tape attaching, adhering, and welding, for example. However, if the lid body 71 can be removed again after being attached to the housing main body part 78, the rotating device 1 can be repaired or replaced in the event of a failure. From this perspective, fitting, threading, locking, screwing, clipping, or tape attaching are preferable.

The rotating device 1 according to the above-described present embodiment includes the axial member 5 at the fixed side and the rotor 3 serving as the rotating body rotating with respect to the axial member 5 via the bearing 4, and thus, as illustrated in FIG. 1, the radial dimension s of the stator 2 can be made smaller than the radial dimension t of the bearing 4 (t>s). This allows the stator 2 to be made very small.

In a rotating device according to a configuration of an outer rotor type brushless motor of the related art in which a rotating body corresponding to the rotor 3 and a shaft corresponding to the axial member 5 are fixed and rotate together, a bearing must be arranged between a stator at the fixed side located inside the rotating body and the axial member, and thus, the radial dimension s of the stator is necessarily larger than the radial dimension t of the bearing 4 (t<s).

However, with the configuration of the present embodiment, it is possible to make the radial dimension s of the stator smaller than the radial dimension t of the bearing (t>s), or to make both the same (t=s), and thus, size reduction of the entire rotating device can be achieved.

The rotating device 1 according to the present embodiment is provided with the rotor blades 6 at the outer peripheral surface of the rotor 3 serving as a rotating body and is provided with the tubular housing 7 so as to surround the rotor blades 6, so that one of both end openings of the housing 7 is a suction port and the other is a discharge port, and the motor part and the rotor blades 6 can be accommodated in the internal space of the housing 7. In particular, since the rotor blades 6 are located in a flow channel (also referred to as a wind channel) through which air flows, space can be reduced, and size reduction of the entire rotating device can be achieved.

In the rotating device 1 according to the present embodiment, the space 77 communicating from the upper end opening to the lower end opening is a cavity so as not to inhibit the flow of air due to members other than the lid spoke part 71a and the stationary blades 8. Since the space 77 has a straight tubular shape except for the space occupied by the cylindrical motor, air can flow straight. Thus, air can be fed out straight from the upper end opening toward the lower end opening by rotating the rotor blades 6. Thus, according to the rotating device 1 according to the present embodiment, air can be efficiently fed out, and a supply of strong wind and large wind volume can be achieved.

In a case where the stationary blades 8 for rectification are to be provided at a part of the housing tubular part 72 located downstream (at the bearing 42 side) of the rotor blades 6, the stationary blades 8 can be accommodated in the internal space of the housing 7 as is, so that space can be reduced, and an increase in the size of the rotating device can be suppressed. At this time, in order to further rectify the air by the stationary blades 8, it is desirable to separate the rotor blades 6 and the stationary blades 8 to a certain extent (to set a predetermined interval). According to the configuration of the present embodiment, the rotor blades 6 and the stationary blades 8 can be aligned in the axial direction of the axial member 5 inside the housing 7, so that the interval between the two can be easily appropriately adjusted. Thus, according to the present embodiment, it is possible to design the air rectification efficiency to be high.

In the present embodiment, in the axial direction (axial line x direction) of the axial member 5, the position of the rotor blades 6 and the position of the first bearing 41 partially overlap with each other, and the position of the stationary blades 8 and the position of the second bearing 42 partially overlap with each other. By arranging the position of the rotor blades 6 at a position at least partially overlapping with the position of the first bearing 41 to bring the position of the rotor blades 6 closer to the upper end opening at the air intake side, the air suction efficiency can be increased, and by disposing the stationary blades 8 at a position at least partially overlapping with the position of the second bearing 42, the interval between the rotor blades 6 and the stationary blades 8 can be ensured, so that the rectification efficiency by the stationary blades can be increased while achieving a small size.

In a rotating device according to a configuration of the related art with a rotating axial member protruding from the motor, since the rotating axial member rotates with a side of the rotating axial member being supported and the rotational force is extracted from the other end side that protrudes, deviation of rotation is likely to occur; however, in the rotating device 1 according to the present embodiment, the rotor 3 itself, supported by the bearing 4, rotates as the rotating body, and thus, the rotation of the rotor 3 is stabilized.

In the rotating device 1 according to the present embodiment, since the first bearing 41 and the second bearing 42 are fixed respectively to both end parts of the rotor 3, and the rotor 3 serving as the rotating body is supported, the rotation of the rotor 3 is stabilized with respect to the axial member 5. In particular, since the magnet 31 as a component of the rotor 3 serving as the rotating body and having a predetermined weight is disposed between the first bearing 41 and the second bearing 42 rotatably supporting the rotor 3 in the axial direction of the axial member 5, the balance in the axial direction is improved and the rotation of the rotor 3 is stabilized.

Note that, the bearings are more preferably disposed at both end parts of the rotating body as in the present embodiment; however, as long as the bearings are near both end parts of the rotating body, the rotation of the rotating body with respect to the axial member is sufficiently stable. The term “near” referred to here means a position near each of both end parts of the rotating body, and although it cannot be expressly defined by a numerical value, for example, a region with a length of 20% from each of both end parts in the axial direction of the rotating body, preferably a region with a length of 10% from each of both end parts, is included in the concept of “near both end parts”.

In the rotating device 1 according to the present embodiment, since the first bearing 41 and the second bearing 42 are members having the same configuration, a balance in the axial direction of a rotating part including the outer peripheral rings 41a and 42a being parts of the bearing 4 and the rotor 3 is improved, and furthermore, a balance in the axial direction of the entire rotating device 1 is improved, so that the rotation of the rotor 3 is stabilized from this perspective as well.

As described above, in the rotating device 1 according to the present embodiment, size reduction of the entire rotating device can be achieved, deviation of rotation of the rotor 3 is unlikely to occur, and high precision stabilization can be achieved.

The stabilization of the rotation of the rotor 3 means that uneven rotation is less likely to occur, and thus, the rotating device 1 can achieve a high torque. In other words, the rotating device 1 according to the present embodiment can provide excellent characteristics as a rotating device while achieving size reduction.

In the first embodiment described above, the example of the configuration of fixing both upper and lower end parts of the axial member 5 to the housing 7 is given; however, it is sufficient that at least one end part or the vicinity of the fixed side of the axial member 5 be fixed to the housing, as long as the axial member 5 at the fixed side is fixed to the housing 7 in some manner.

In the first embodiment, the fixing member 92 is fixed to the part at the lower side b side of the disc part 71c, and the disc spring 91 is fixed in a state of being pressed from the upper side by the fixing member 92, but the present invention is not limited to this configuration. As necessary, both the fixing member 92 and the disc spring 91 or one of them need not be provided.

As necessary, a spacer may be provided between the second bearing 42 and the magnet 31 in the axial direction of the axial member 5, and the spacer may be used to position the second bearing 42 at the inner surface of the tubular member 32 in the axial direction of the axial member. In this case, of the end part at the second bearing 42 side of the magnet 31, a part near the stator 2 may be disposed so as to protrude toward the second bearing 42 side to support the spacer.

As necessary, a spacer need not be provided between the second bearing 42 and the magnet 31 in the axial direction of the axial member 5.

In the first embodiment, the rotating device 1 is provided with the housing 7, but need not be provided with the housing 7 as necessary. Thus, the rotating device 1 of the present application includes a configuration in which the housing 7 is provided or is not provided. The present application discloses a rotating device including an axial member, a tubular rotating body rotatable in relation to the axial member, a bearing supporting the rotating body with respect to the axial member, a stator inside the rotating body, and one or a plurality of rotor blades provided to the rotating body. According to the rotating device, size reduction can be achieved. It is disclosed that the rotating device includes a magnet attached to the inner surface of the tubular member, an end part of the magnet at the first bearing side is closer to a second bearing side than an end part of the stator at the first bearing side, an end part of the magnet at the second bearing side is closer to the second bearing side than an end part of the stator at the second bearing side, and each rotor blade is in a position overlapping with the first bearing or the end part of the magnet at the first bearing side in the axial direction of the axial member. Furthermore, it is disclosed that the rotating device includes a part of the magnet (for example, an end part at the first bearing side) provided at a position overlapping with a part of the rotor blades in the axial direction of the axial member. According to this rotating device, the balance in the axial direction can be improved.

As necessary, the housing tubular part 72 and the lower support part 74 may be formed integrally or formed of one member.

In the first embodiment, the rotor blades 6 protruding toward the inner peripheral surface of the housing 7 (toward the outer peripheral side c) are attached at the outer peripheral surface of the tubular member 32 of the rotor 3 in a region overlapping with the first bearing 41 in the axial direction (the axial line x direction) of the axial member 5. Not limited to the above description, the rotor blades 6 may be attached to the outer peripheral surface of the tubular member 32 of the rotor 3 directly or via another member.

In the first embodiment, a plurality of the rotor blades 6 protruding toward the inner peripheral surface of the housing 7 (toward the outer peripheral side c) are attached in a circumferential direction at the outer peripheral surface of the tubular member 32 of the rotor 3 in a region overlapping with the first bearing 41 in the axial direction (the axial line x direction) of the axial member 5. Not limited to the above description, the plurality of rotor blades may be arranged in the axial direction of the axial member 5.

### Second Embodiment

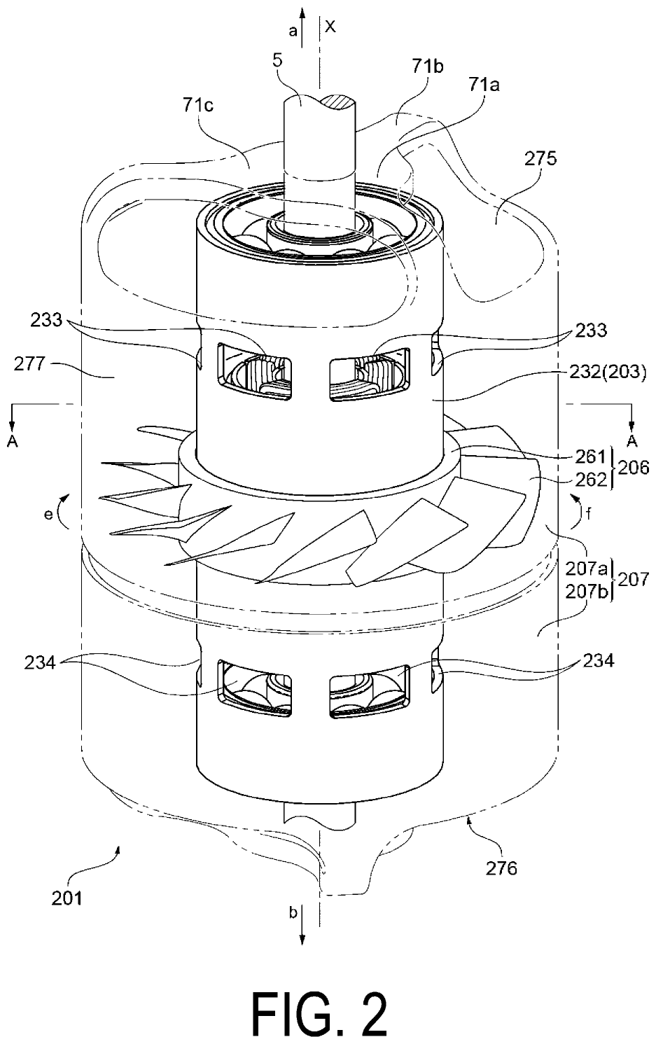

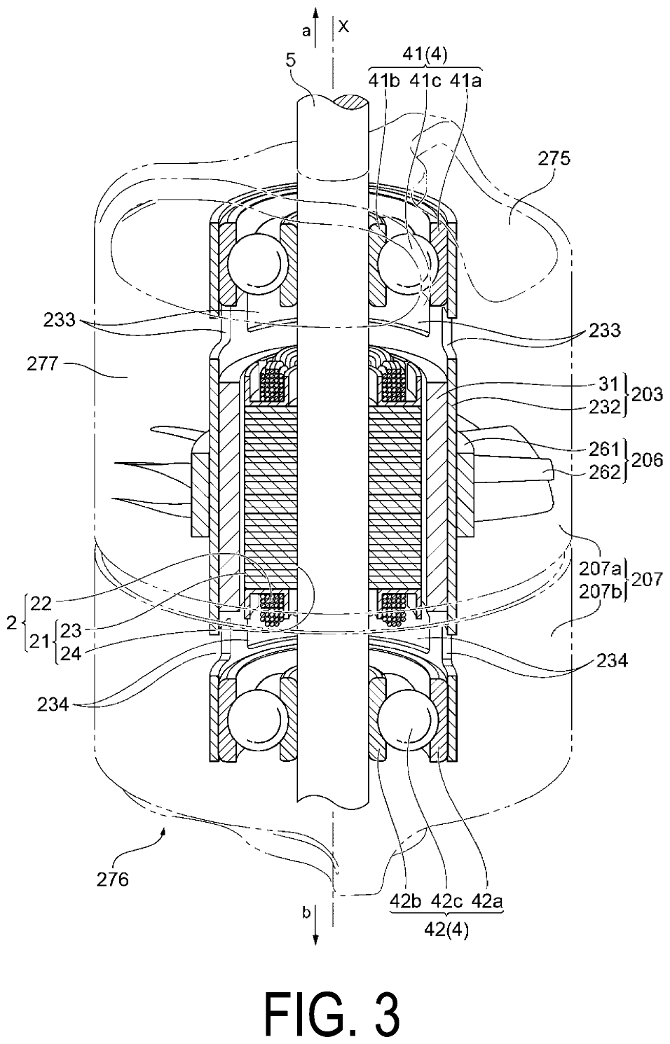

FIG. 2 is a transparent perspective view of a rotating device 201 according to a second embodiment, being one example of the present invention, and FIG. 3 is a transparent cross-sectional view of a cross section including an axial line x of the rotating device 201. In FIGS. 2 and 3, the housing 207 is illustrated in a transparent state by being drawn with imaginary lines (two-dot chain lines).

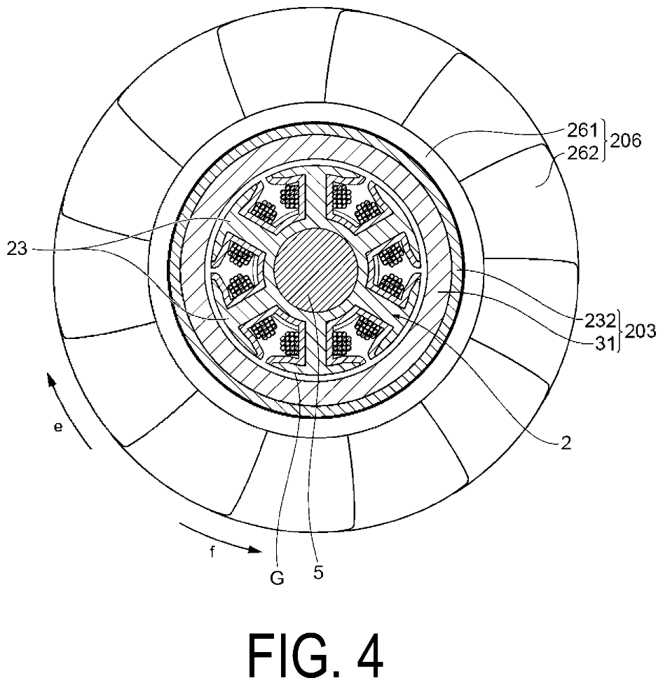

FIG. 4 is a cross-sectional view of a cross section (cross section A-A in FIG. 2) perpendicular to the axial line x direction of the rotating device 201. Note that, in FIG. 4, an imaginary line illustrating the housing 207 is omitted.

In FIGS. 2, 3, and 4 according to the present embodiment, members having the same configuration as those of the first embodiment are given the same reference numerals, and detailed descriptions of the members will be omitted. In the following description, configurations specific to the present embodiment will be mainly described.

A suction port and a discharge port described in the embodiments below are ventilation openings and are described as the suction port and the discharge port for convenience in correspondence with the direction of air. Depending on the direction of air, the suction port serves as the discharge port, and the discharge port serves as the suction port, and the present invention is not limited by the description of the suction port and the discharge port in each embodiment.

In the rotating device 201 according to the present embodiment, the housing 207 is constituted by two members, the two members being a first housing (hereinafter, referred to as an upper housing) 207a and a second housing (hereinafter referred to as a lower housing) 207b, having tubular shapes. The integrated housing 207 is formed by fitting and fixing the upper housing 207a and the lower housing 207b to each other as illustrated in FIGS. 2 and 3.

Some of the components of the rotating device 201 are accommodated inside the housing 207, and the axial member 5 is fixed to an upper end part of the upper housing 207a and a lower end part of the lower housing 207b. The housing 207 and the axial member 5 constitute members at the fixed side. An upper end opening 275 and a lower end opening 276 are provided at the upper end part of the upper housing 207a and the lower end part of the lower housing 207b respectively, and the upper opening 275 and the lower opening 276 each surround the axial member 5.

In the rotating device 201 according to the present embodiment, the rotor blades 206 are attached to a center part in the axial line x direction at the outer peripheral surface of a rotor 203. The rotor blades 206 are provided with a plurality of blades 262 at predetermined intervals at the outer peripheral surface of the tubular part 261 and extending radially in the circumferential direction. As illustrated in FIG. 4, when viewed from one side (the upper side a in FIG. 4) in the axial line x direction, parts of the rotor blades 206 overlap with each other and are in a state of being disposed without a gap.

The rotor blades 206 rotate together with the rotor 203 and, by the rotated rotor blades 206, a flow of air occurs depending on the rotation of the rotor blades 206. This flow of air occurs toward either the upper direction or the lower direction in the axial direction of the axial member 5 in a space 277 between the housing 207 and the rotor 203.

In the rotating device 201 according to the present embodiment, the rotating device 201 is configured to be driven to rotate the rotor blades 206 in the counterclockwise circumferential direction f so that air taken in from the upper end opening 275 is blown out from the lower end opening 276.

In the axial direction (the axial line x direction) of the axial member 5, the rotor blades 206 are disposed in the center part of the outer peripheral surface of the rotor 203 (rotating body). Since the amplitude of vibration generated in the rotor 203 in the axial direction of the axial member 5 is relatively small in the position of the center of the rotor 203, the vibration generated in the rotor 203 is less likely to propagate to the housing 207, so that the generation of vibration in the entire rotating device can be suppressed.

A suction port 233 as the ventilation opening and a discharge port 234 as the ventilation opening are provided at a tubular member 232 of the rotor 203. The suction port 233 is provided at a part of the tubular member 232 between the first bearing (bearing) 41 and the rotor blades 206 in the axial direction (axial line x direction) of the axial member 5. The discharge port 234 is provided at a part of the tubular member 232 between the second bearing (bearing) 42 and the rotor blades 206. The suction port 233 and the discharge port 234 are formed in a rectangular shape with the circumferential directions e and f being the longitudinal direction. A plurality of the suction ports 233 and a plurality of the discharge ports 234 are each aligned at equal intervals in the circumferential directions e and f. Note that, depending on the direction of rotation of the rotor 203, the suction port 233 may serve as the discharge port, and the discharge port 234 may serve as the suction port.

The air is suctioned from the suction port 233 into the inside of the rotor 203 and the air is discharged from the discharge port 234 due to an effect of air generated in the space 277 toward the lower direction (arrow b direction) by the rotation of the rotor blades 206. The air taken in from the suction port 233 passes between the plurality of magnetic pole parts 23 of the stator core 21 and a magnet gap G formed between the magnet 31 and the stator 2, and is discharged from the discharge port 234, while cooling the stator 2 including the stator core 21 and the coil 22 inside the rotor 3.

Accordingly, in the rotating device 201 according to the present embodiment, a large amount of cooling air can be fed into the inside of the rotor 203, and the stator 2 provided with a heated coil can be efficiently cooled.

Also in the present embodiment, a similar configuration as that of the first embodiment produces similar actions and similar effects are provided.

### Third Embodiment

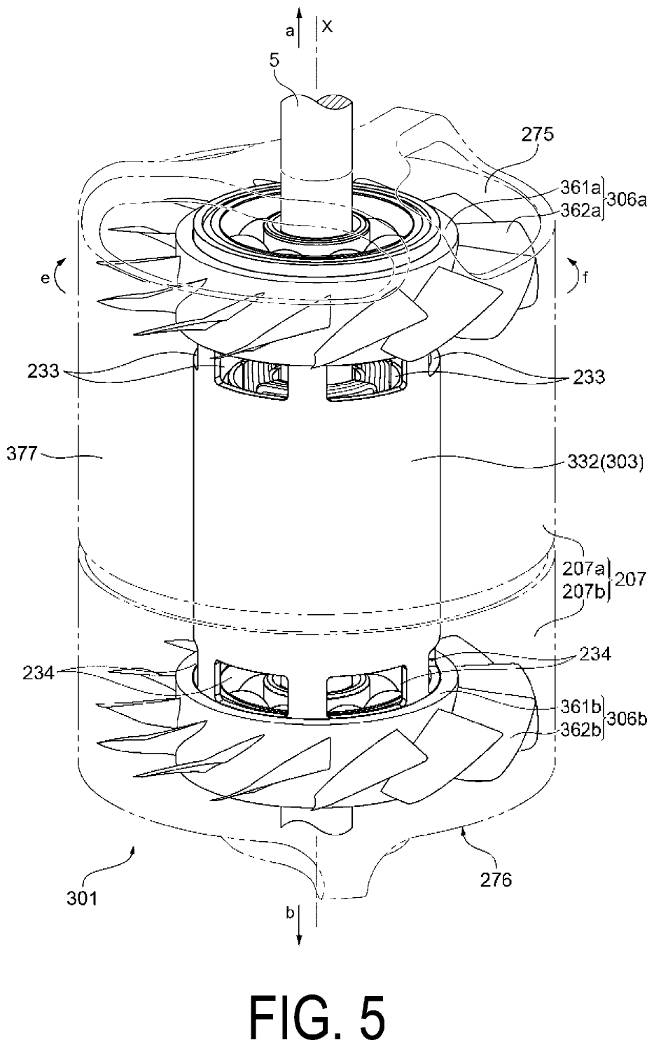

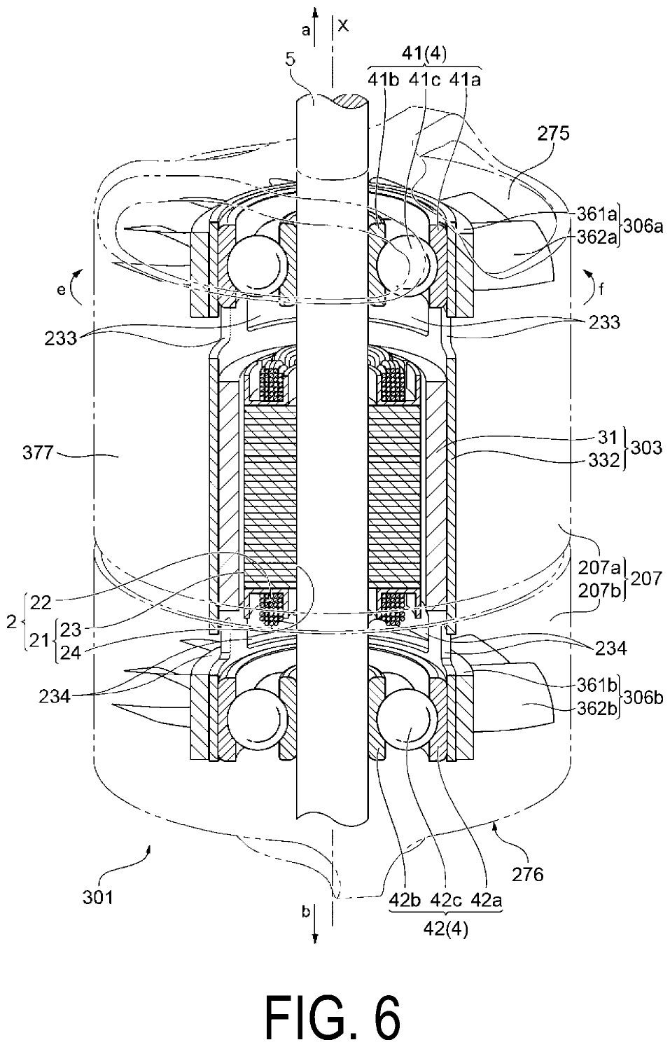

FIG. 5 is a transparent perspective view of a rotating device 301 according to a third embodiment being one example of the present invention, and FIG. 6 is a transparent cross-sectional view of a cross section including an axial line x of the rotating device 301.

Note that in FIGS. 5 and 6 according to the present embodiment, members having the same configuration as those of the first embodiment or the second embodiment are given the same reference numerals, and detailed descriptions of the members will be omitted. In the following description, in the present embodiment, configurations different from those of the above-described embodiments will be mainly described.

In the rotating device 301 according to the present embodiment, two rotor blades 306a and 306b are attached to two locations, upper and lower locations in the axial line x direction, at the outer peripheral surface of a rotor 303. The rotor blades 306a and 306b have the same shape, are similar to the rotor blades 206 of the second embodiment, and include a plurality of blades 362a and 362b arranged radially at predetermined intervals at the outer peripheries of tubular parts 361a and 361b. Other configurations are also similar to that of the rotor blades 206 of the second embodiment.

The rotor blades 306a and 306b rotate together with the rotor 303, a flow of air is generated by the rotation of the rotor blades 306a and 306b, and air flows toward either an upper or lower direction in a space 377. By providing two rotor blades 306a and 306b, wind volume and wind speed can be increased.

In the rotating device 301 according to the present embodiment, the rotating device 301 is configured to be driven to rotate the rotor blades 306a and 306b in the counterclockwise circumferential direction f so that air taken in from the upper end opening 275 is blown out from the lower end opening 276.

In the radial direction of the rotor 303, the rotor blades 306a are disposed at the outer peripheral surface of the tubular member 332 at the housing 207 side with respect to the bearing 41. In the radial direction of the rotor 303, the rotor blades 306b are disposed at the outer peripheral surface of the tubular member 332 at the housing 207 side with respect to the bearing 42. The rotor blades 306a and 306b are disposed at an equal distance from the center part of the rotor 303 (rotating body) in the axial direction (the axial line x direction) of the axial member 5.

In the axial direction (axial line x direction) of the axial member 5, the position of the rotor blades 306a and the position of the first bearing 41 overlap with each other, and the position of the rotor blades 306b and the position of the second bearing 42 overlap with each other. By disposing the rotor blades 306a at a position at least partially overlapping with the position of the first bearing 41 to bring the position of the rotor blades 306a closer to the upper end opening 275 at the air intake side, the air suction efficiency can be increased. By disposing the rotor blades 306b at a position at least partially overlapping with the position of the second bearing 42 to bring the position of the rotor blades 306b closer to the lower end opening 276 at the air blowing side, the air blowing efficiency can be increased.

The suction port 233 is provided at a position at the rotor blades 306b side with respect to the rotor blades 306a and the discharge port 234 is provided at a position at the rotor blades 306a side with respect to the rotor blades 306b, in the direction the air is made to flow by the rotor blades 306a and the rotor blades 306b (in other words, the same as the axial direction (axial line x direction) of the axial member 5).

For example, air taken in from the upper end opening 275 and fed by the rotor blades 306a is at a relatively high pressure in a region that is a part of the space 377 at the rotor blades 306b side with respect to the rotor blades 306a. Since the suction port 233 is provided at a relatively high pressure region, cooling air inside the rotor 303 (hereinafter, may be simply referred to as “cooling air”) is efficiently suctioned into the rotor 303 so as to be pushed from the suction port 233 into the space inside the rotor 303, separately from a flow of air passing between the housing 207 and the rotor 303 (hereinafter, also referred to as “main air flow”). The air is fed out to the lower end opening 276 by the rotor blades 306b, and the pressure is relatively low in a region that is another part of the space 377 at the rotor blades 306a side with respect to the rotor blades 306b. Since the discharge port 234 is provided at the region that is another part of the space 377 that has a relatively low pressure, the cooling air is efficiently discharged to the outside of the rotor 303 so as to be drawn from the inside of the rotor 303.

Accordingly, in the rotating device 301 according to the present embodiment, a larger amount of cooling air can be fed into the inside of the rotor 303, and the stator 2 provided with a heating coil can be more efficiently cooled.

Also in the present embodiment, a similar configuration to that of the first embodiment or the second embodiment produces similar actions and similar effects are provided.

### Fourth Embodiment

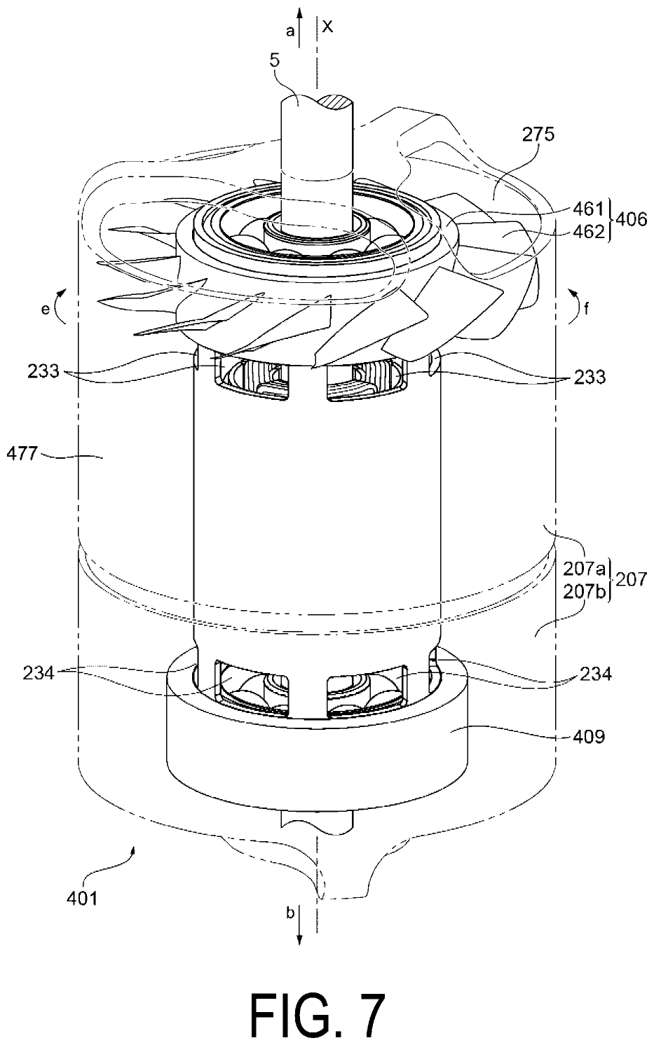

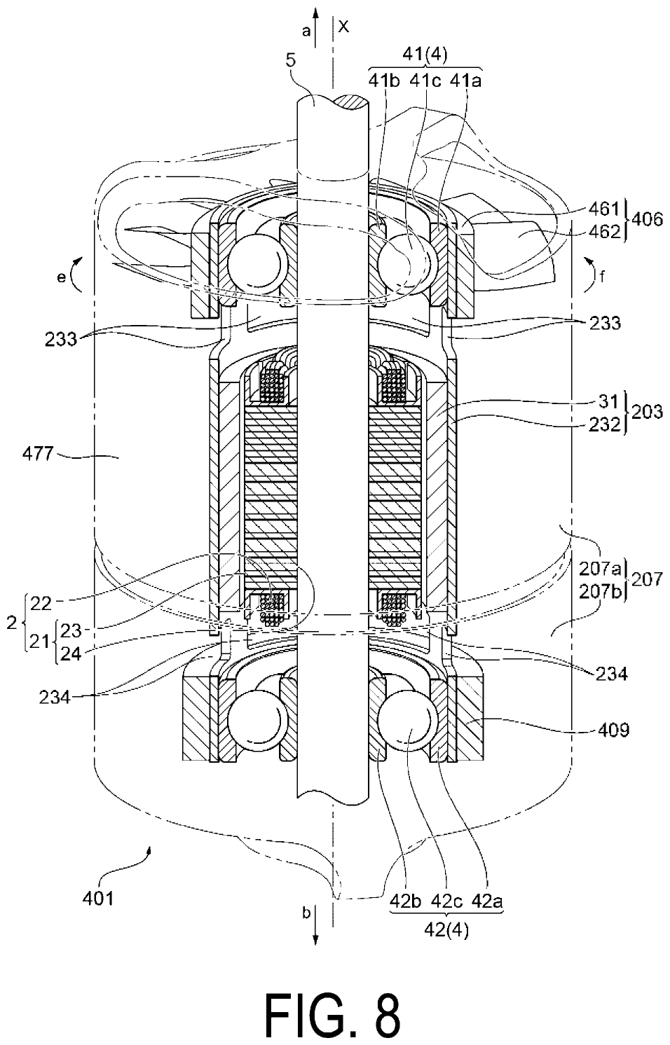

FIG. 7 is a transparent perspective view of a rotating device 401 according to a fourth embodiment being one example of the present invention, and FIG. 8 is a transparent cross-sectional view of a cross section including an axial line x of the rotating device 401.

Note that in FIGS. 7 and 8 according to the present embodiment, members having the same configuration as those of the first embodiment or the second embodiment are given the same reference numerals, and detailed descriptions of the members will be omitted. In the following description, configurations specific to the present embodiment will be mainly described.

In the rotating device 401 according to the present embodiment, the rotor blades 406 are attached to a part at the upper side (at a bearing 406 side) in the axial line x direction at the outer peripheral surface of a rotor 203. The rotor blades 406 are the same as the rotor blades 206 of the second embodiment, and include a plurality of blades 462 arranged at predetermined intervals at an outer peripheral surface of a tubular part 461, and extending radially in the radial direction. Other configurations are also similar to that of the rotor blades 206 of the second embodiment.

In the rotating device 401 according to the present embodiment, a position of the rotor blades 406 overlaps with the position of the bearing 41 in the axial direction (axial line x direction) of the axial member 5, and a part of the rotor blades 406 opposes the bearing 41 via the tubular member 232 in the radial direction. A ring member 409 (hereinafter referred to as a balancing ring) is provided at the tubular member 232 in the axial direction (axial line x direction) of the axial member 5. The position of the balancing ring 409 overlaps with the position of the bearing 42, and a part of the balancing ring 409 opposes the bearing 42 via the tubular member 232 in the radial direction.

In the axial direction (axial line x direction) of the axial member 5, the balancing ring 409 is disposed at a position symmetrical to the rotor blades 406 centered at the center part of the rotor 203 (rotating body). The weight of the balancing ring 409 is adjusted so that weights at both end parts of the rotor 203 are equal to each other in the axial direction of the axial member 5. Alternatively, the weight of the balancing ring is adjusted to be the same as that of the rotor blades 406. Thus, for the member at the rotating side (such as the rotor 203, the rotor blades 406 and the balancing ring 409), a position of the center of gravity in the axial direction (the axial line x direction) of the axial member 5 is adjusted to be the center of the rotor 203, for example. The balancing ring is formed of a member serving as a weight, such as a resin member or a metal member, for example.

The position of the rotor blades 406 and the position of the first bearing 41 overlap with each other in the axial direction (axial line x direction) of the axial member 5. By disposing the rotor blades 406 at a position at least partially overlapping with the position of the first bearing 41 to bring the position of the rotor blades 406 closer to the upper end opening 275 at the air intake side, the air suction efficiency can be increased.

The suction port 233 is provided at a position at the balancing ring 409 side with respect to the rotor blades 406 in a direction of air by the rotor blades 406 (in other words, the same as the axial direction (axial line x direction) of the axial member 5) in the axial direction of the axial member 5.

Accordingly, in the rotating device 401 according to the present embodiment, a larger amount of cooling air can be fed into the inner space of the rotor 203, and the stator 2 including a heated coil can be more efficiently cooled.

Also in the present embodiment, a similar configuration to that of the first embodiment or the second embodiment produces similar actions and similar effects are provided.

### Fifth Embodiment

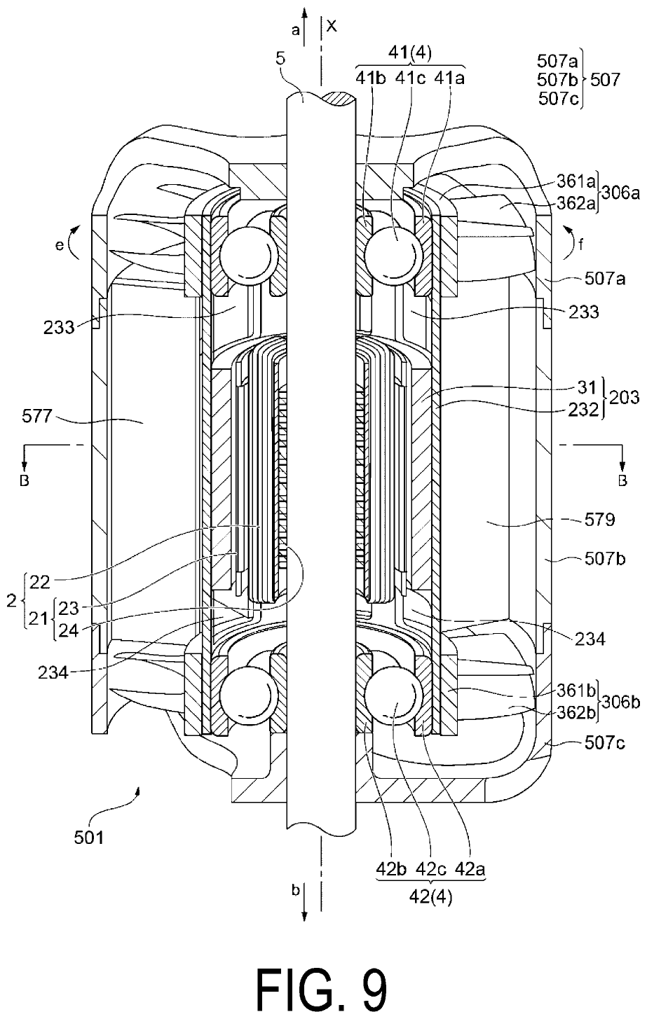

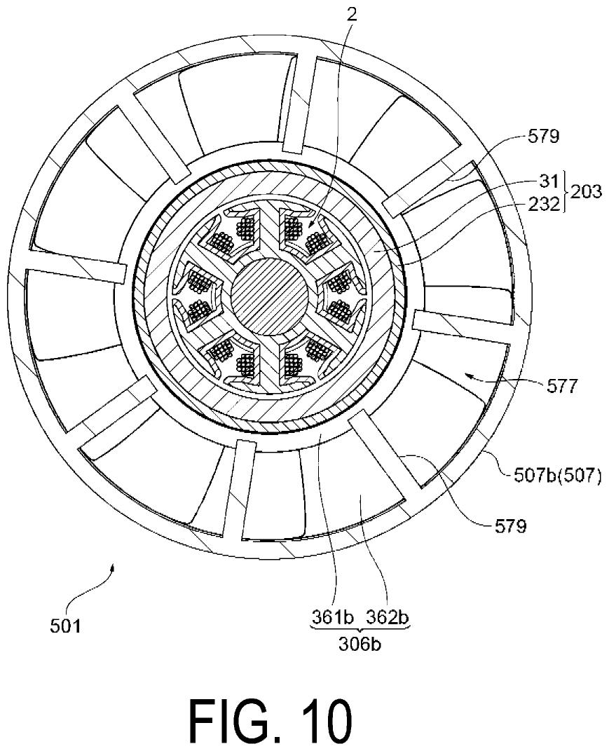

FIG. 9 is a cross-sectional view of a cross section including an axial line x of a rotating device 501 according to a fifth embodiment being one example of the present invention. FIG. 10 is a cross-sectional view of a cross section (cross section B-B in FIG. 9) perpendicular to the axial line x direction of the rotating device 501.

Note that in FIGS. 9 and 10 according to the present embodiment, members having the same configuration as those of the third embodiment (further, the first embodiment or the second embodiment) are given the same reference numerals, and detailed descriptions of the members will be omitted. In the following description, configurations specific to the present embodiment will be mainly described.

In the rotating device 501 according to the present embodiment, only the configuration of a housing 507 differs from the rotating device 301 according to the third embodiment. In other words, in the present embodiment, the housing 507 includes three members, the three members being a recessed first housing (hereinafter, referred to as an upper housing) 507a, a tubular second housing (hereinafter, referred to as a middle housing) 507b, and a recessed third housing (hereinafter, referred to as a lower housing) 507c. In the upper housing 507a, an upper end opening 275 is formed on an upper part serving as one end part of the housing 507. In the lower housing 507c, a lower end opening 276 is formed at a lower part serving as the other end part of the housing 507. The integrated housing 507 is configured by fitting and fixing the upper housing 507a, the middle housing 507b, and the lower housing 507c to each other as illustrated in FIG. 9.

The rotor blades 306a are disposed in a state of being surrounded by the upper housing 507a. The rotor blades 306b are disposed in a state of being surrounded by the lower housing 507c. Thus, in a case where the configuration is the same as that of the third embodiment, there is a cavity to be an open space in a space 577 between the middle housing 507b and the rotor 203. In the present embodiment, stationary blades 579 are provided at this space 577. This stationary blades 579 are provided, for example, at a part of the inner peripheral surface of the housing 307 located between the two blades 306a and 306b, or a part of the inner peripheral surface of the housing 207 located between the rotor blades 406 and the balancing ring 409 in the fourth embodiment, and such stationary blades are referred to hereinafter as “intermediate stationary blades”.

As illustrated in FIG. 10, the intermediate stationary blades 579 extend from a part of the inner peripheral surface of the middle housing 507b in the axial line x direction and extend from the part of the inner peripheral surface of the middle housing 507b toward the rotor 203. The intermediate stationary blades 579 have a plate-like shape configured by a surface parallel with the axial line x, and a plurality (eight in the present embodiment) of the intermediate stationary blades 579 are provided at equal intervals in the circumferential directions e and f By providing the plurality of intermediate stationary blades 579, the space 577 is partitioned into a plurality (eight in the present embodiment) of passages of wind (hereinafter referred to as “wind passages”) along the flow channel through which air flows by the plurality of intermediate stationary blades 579.

According to the present embodiment, by partitioning the space 577 into the plurality of wind passages by the intermediate stationary blades 579, the flow of air is rectified and the wind volume can be increased.

In the rotating device 501 according to the present embodiment, similarly to the second to fourth embodiments, each of the suction port 233 and the discharge port 234 is provided to the tubular member 232 of the rotor 203. By combining the suction port 233, the discharge port 234, and the intermediate stationary blades 579, cooling air can be more efficiently taken inside the rotor 3.

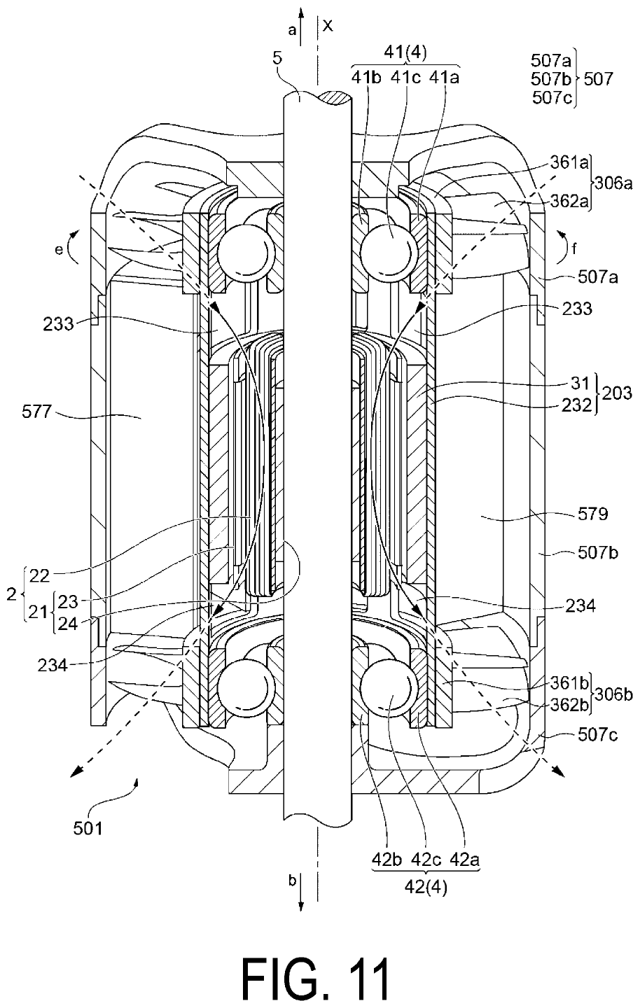

An explanatory diagram for explaining a flow of cooling air to the inside of a rotor 3 is illustrated in FIG. 11. FIG. 11 is a transparent cross-sectional view similar to FIG. 9.

The suction port 233 is provided at a position at the rotor blades 306b side with respect to the rotor blades 306a and the discharge port 234 is provided at a position at the rotor blades 306a side with respect to the rotor blades 306b, in the main direction of air by the rotor blades 306a and the rotor blades 306b (in other words, the same as the axial direction (axial line x direction) of the axial member 5). In the axial direction (the axial line x direction) of the axial member 5, the position of the suction port 233 overlaps with a position of an upper end part of the intermediate stationary blades 579, and the position of the discharge port 234 overlaps with a position of a lower end part of the intermediate stationary blades 579.

The air taken in from the upper end opening 275 and fed by the rotor blades 306a flows into a region of a part of the space 577 at the rotor blades 306b side with respect to the rotor blades 306a. The air that has flowed into this region passes through the space partitioned by the plurality of intermediate stationary blades 579 to be rectified, and separately from the main air, is pushed in a state of being rectified from the suction port 233 provided at this region to the inside of the rotor 203, and cools the stator 2.

Thus, as illustrated by the dotted arrows in FIG. 11, the air is more efficiently suctioned into the rotor 203. As indicated by solid arrows in FIG. 11, the cooling air taken in from the suction port 233 passes through a gap formed in the stator 2 (for example, a gap between the plurality of magnetic pole parts 23, and a gap G between the stator core 21 and the magnet 31) and flows toward the bearing 42, while cooling the stator 2 including the stator core 21 and the coil 22 inside the rotor 203.

On the other hand, in the main air, the air is fed out to the lower end opening 276 by the rotor blades 306b, and flows into a region of a part of the space 577 at the rotor blades 306a side with respect to the rotor blades 306b. The air that has flowed into this region passes through the space partitioned by the plurality of intermediate stationary blades 579 to be rectified, and then the air is discharged into the lower end opening 276 by the rotor blades 306b. Thus, as illustrated by the dotted arrows in FIG. 11, the main air is more efficiently discharged together with cooling air discharged from the inside of the rotor 203.

Accordingly, in the rotating device 501 according to the present embodiment, an even larger amount of cooling air can be fed into the inside of the rotor 203, and the stator 2 including a heated coil can be even more efficiently cooled.

Also in the present embodiment, a similar configuration to that of the first embodiment, the second embodiment, or the third embodiment produces similar actions and similar effects are provided.

### Sixth Embodiment

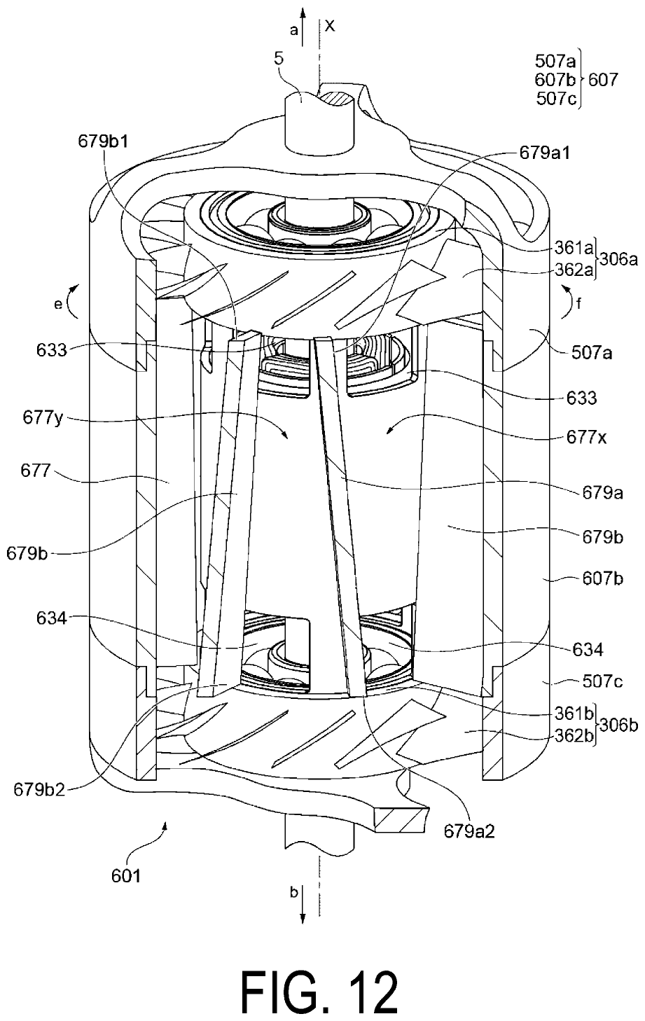

FIG. 12 is a transparent cross-sectional view of a cross section parallel to the axial line x, cut in front of the axial line x of a rotating device 601 according to a sixth embodiment being one example of the present invention. In the rotating device 601 according to the present embodiment, only the configuration of stationary blades provided to the inner peripheral surface of the middle housing differs from the rotating device 501 according to the fifth embodiment.

Thus, similarly to the fifth embodiment, in FIG. 12 according to the present embodiment, members having the same configuration as those of the third embodiment (further, the first embodiment or the second embodiment) are given the same reference numerals, and detailed descriptions of the members will be omitted. In the following description, configurations specific to the present embodiment will be mainly described.

Similarly to the fifth embodiment, a housing 607 in the present embodiment includes three members, the three members including the upper housing 507a, a tubular middle housing 607b, and the lower housing 507c. The integrated housing 607 is formed by fitting and fixing the upper housing 507a, the middle housing 607b, and the lower housing 507c to each other as illustrated in FIG. 12.

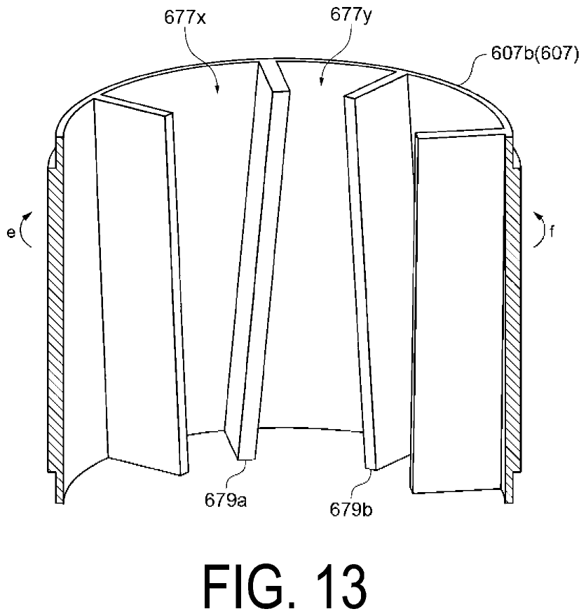

FIG. 13 is a cross-sectional view of the middle housing 607b, together with intermediate stationary blades (stationary blades) 679a and 679b provided at an inner peripheral surface of the middle housing 607b, extracted from the rotating device 601 according to the present embodiment and cut out at a cross section including an axial line x. As illustrated in FIG. 13, similarly to that of the fifth embodiment, the intermediate stationary blades 679a and 679b have a plate-like shape and extend from the inner peripheral surface of the middle housing 607b in the axial line x direction. In the radial direction of the rotor 203, the intermediate stationary blades 679a and 679b extend from the inner peripheral surface of the middle housing 607b toward the rotor 203. However, unlike the fifth embodiment, the intermediate stationary blades 679a and 679b have surfaces inclined with respect to the axial line x.

The intermediate stationary blades 679a are provided to be inclined in a counterclockwise direction (circumferential direction f) from the upper side (a part of the middle housing 607b at the bearing 41 side) toward the lower side (the other part of the middle housing 607b at the bearing 42 side), and the intermediate stationary blades 679b are provided to be inclined in a clockwise direction (circumferential direction e) from the upper side toward the lower side.

The intermediate stationary blades 679a and the intermediate stationary blades 679b are disposed alternately in the circumferential directions e and f, and the directions of inclination are staggered with respect to each other. Specifically, in the circumferential direction of the rotor 203, among each of the intermediate stationary blades 679a, a position of one end part 679a1 (end part at the bearing 41 side or the rotor blades 306a side) is different from a position of the other end part (end part at the bearing 42 side or the rotor blades 306b side). Similarly, in the circumferential direction of the rotor 203, among each of the intermediate stationary blades 679b, a position of one end part 679b1 (end part at the bearing 41 side or the rotor blades 306a side) is different from a position of the other end part 679b2 (end part at the bearing 42 side or the rotor blades 306b side).

In the circumferential direction of the rotor 203, the one end part 679a1 of the intermediate stationary blades 679a is close to the one end part 679b1 of the intermediate stationary blades 679b, and the other end part 679a2 of the intermediate stationary blades 679a is separated from the other end part 679b2 of the intermediate stationary blades 679b. In other words, in the circumferential direction of the rotor 203, a distance between the one end part 679a1 of the intermediate stationary blades 679a and the one end part 679b1 of the intermediate stationary blades 679b is shorter than a distance between the other end part 679a2 of the intermediate stationary blades 679a and the other end part 679b2 of the intermediate stationary blades 679b.

By providing the intermediate stationary blades 679a and the intermediate stationary blades 679b, the space 677 is partitioned into a plurality (eight in the present embodiment) of wind passages along a main flow channel of air.

According to the present embodiment, by partitioning the space 677 into a plurality of wind passages 677x and 677y by the intermediate stationary blades 679a and 679b, the flow of air is rectified and the wind volume can be increased.

In the circumferential direction of the rotor 203, a width of the wind passage 677x between the intermediate stationary blades 679a and the intermediate stationary blades 679b adjacent to the intermediate stationary blades 679a at the circumferential direction f side is formed so as to narrow toward the direction the air is flowing. On the other hand, in the circumferential direction of the rotor 203, a width of the wind passage 677y between the intermediate stationary blades 679a and the intermediate stationary blades 679b adjacent to the intermediate stationary blades 679a at the circumferential direction e side is formed so as to expand toward the direction the air is flowing. In other words, in the wind passage 677x formed by the intermediate stationary blades 679a and 679b adjacent to each other, the wind passage 677x at the bearing 41 side or the rotor blades 306a side is wide, and the wind passage 677x at the bearing 42 side or the rotor blades 306b side is narrow.

In the main direction (in other words, the same as the axial direction (axial line x direction) of the axial member 5) of air made to flow by the rotor blades 306a and the rotor blades 306b, a ventilation opening 633 is provided at a position at the rotor blades 306b side with respect to the rotor blades 306a and a ventilation opening 634 is provided at a position at the rotor blades 306a side with respect to the rotor blades 306b. The ventilation opening 633 is the same as the suction port 233, respectively in the second to fifth embodiments. The ventilation opening 634 is the same as the discharge port 234, respectively in the second to fifth embodiments. In the axial direction (the axial line x direction) of the axial member 5, the position of the ventilation opening 633 overlaps with positions of upper end parts of the intermediate stationary blades 679a and 679b and the position of the ventilation opening 634 overlaps with positions of lower end parts of the intermediate stationary blades 679a and 679b.

In the wind passage 6′7′7y, air in the wind passage 6′7′7y at the upstream side (at the bearing 41 side or the rotor blades 306a side) is dense, and air in the wind passage 6′7′7y at the downstream side (at the bearing 42 side or the rotor blades 306b side) is sparse. As a result, since the wind passage 677y expands toward the downstream side, the air goes from being dense to being sparse and is expanded, the pressure at the wind passage 677y at the lower end part side (the bearing 42 side or the rotor blades 306b side) becomes a low pressure, and the pressure at the wind passage 677y at the upper end part side (the bearing 41 side or the rotor blades 306a side) becomes a relatively high pressure. Due to this pressure difference, the air in the wind passage 677y having a relatively high pressure is taken into the rotor 203 as cooling air via the ventilation opening 633, and the air in the wind passage 677y having a relatively low pressure is discharged to the outside of the rotor 203 as cooling air via the ventilation opening 634.

In the wind passage 677x, the flow of the cooling air passing through the ventilation openings 633 and 634 is opposite to that of the wind passage 677y.

In the wind passage 677x, air in the wind passage 677x at the downstream side (at the bearing 42 side or the rotor blades 306b side) is dense, and air in the wind passage 677x at the upstream side (at the bearing 41 side or the rotor blades 306a side) is sparse.

As a result, since the wind passage 677x expands toward the upstream, the air goes from being sparse to being dense and is compressed, the pressure of the wind passage 677x at the lower end part side (the bearing 42 side or the rotor blades 306b side) becomes a relatively high pressure, and the pressure of the wind passage 677x at the upper end part side (the bearing 41 side or the rotor blades 306a side) becomes a relatively low pressure. Due to this pressure difference, the air in the wind passage 677x being a relatively high pressure is taken into the rotor 203 as cooling air via the ventilation opening 634, and the air in the wind passage 677x being a relatively low pressure is discharged to the outside of the rotor 203 as cooling air via the ventilation opening 633.

As described above, in the rotating device 601 according to the present embodiment, in the circumferential directions e and f, due to the plurality of intermediate stationary blades 679a and the plurality of intermediate stationary blades 679b forming an array of two different directions of inclination in a staggered manner. the widths of the wind passages 677x and 677y gradually change in the traveling direction of air. Thus, in each of the wind passages 677x and 677y, a pressure difference occurs between the upstream and downstream of the flow of air. The ventilation openings 633 and 634 are disposed at the upper end parts and the lower end parts of the wind passages 677x and 6′7′7y the pressure difference being increased, so that the cooling air is forcibly taken into the rotor 203 or discharged through the ventilation openings 633 and 634.

Accordingly, in the rotating device 601 according to the present embodiment, an even larger amount of the cooling air can be forcibly fed into the inside of the rotor 203, and the stator 2 including a heating coil can be efficiently cooled.

Also in the present embodiment, a similar configuration to that of the first embodiment, the second embodiment, the third embodiment, or the fifth embodiment produces similar actions and similar effects are provided.

As described above, the rotating device according to the present invention is described with reference to a preferred embodiment, but the rotating device according to the present invention is not limited to the configurations of the embodiments described above. For example, the configurations specific to each of the embodiments may be combined. As an example, a configuration specific to the first embodiment (such as the configuration of applying the preload to the inner peripheral ring 41b of the first bearing 41 by the disc spring 91) may be applied to the second to sixth embodiments.

The intermediate stationary blades 579 and intermediate stationary blades 679a and 679b specific to the fifth embodiment and the sixth embodiment described using the example of including the pair of upper and lower rotor blades 306a and 306b may be applied to the fourth embodiment (together with the housing 507 and the housing 607). In the fourth embodiment, the rotor blades 406 at the upper side and the balancing ring 409 at the lower side are paired, and there is the space 477 capable of being provided with the intermediate stationary blades 579 or the intermediate stationary blades 679 and 679b, between the rotor blades 406 and the balancing ring 409.

The air may be a gas such as a refrigerant.

In addition, the rotating device according to the present invention may be appropriately modified by a person skilled in the art according to conventionally known knowledge. Such modifications are of course included in the scope of the present invention as long as these modifications still include the configuration of the present invention.

### REFERENCE SIGNS LIST

1 Rotating device
2 Stator
3 Rotor (rotating body)
4 Bearing
5 Axial member
6 Rotor blade
7 Housing
8 Stationary blade
21 Stator core
22 Coil
23 Magnetic pole part
24 Annular part
31 Magnet
32 Tubular member
41 First bearing (bearing)
41a, 42a Outer peripheral ring
41b, 42b Inner peripheral ring
41c, 42c Bearing ball
42 Second bearing (bearing)
71 Lid body
71a Lid spoke part
71b Lid tubular part
71ba Protruding part
71bb Notched part
71c Disc part
71d Rib
72 Housing tubular part
72a Protruding part
72b Notched part
74 Lower support part
74a Outer tubular part
74b Bottom surface part
74c Inner tubular part
77 Space
78 Housing main body part
91 Disc spring
92 Fixing member
201 Rotating device 201
203 Rotor
206 Rotor blade
207 Housing
207a Upper housing
207b Lower housing
232 Tubular member
233 Suction port
234 Discharge port
261 Tubular part
262 Blade
275 Upper end opening
276 Lower end opening
277 Space
301 Rotating device 201
303 Rotor
306a, 306b Rotor blade
361a, 361b Tubular part
362a, 362b Blade
377 Space
401 Rotating device
403 Rotor
406 Rotor blade
409 Balancing ring (ring member)
461 Tubular part
462 Blade
501 Rotating device
507 Housing
507a Upper housing
507b Middle housing
507c Lower housing
577 Space
579 Intermediate stationary blade (stationary blade)
601 Rotating device
607 Housing
607b Middle housing
633 Ventilation opening
634 Ventilation opening
677 Space
677x, 677y Wind channel
679a, 679b Intermediate stationary blade (stationary blade)

1. A rotating device comprising:
an axial member;
a tubular rotating body rotatable in relation to the axial member;
a tubular housing surrounding the rotating body;
a bearing supporting the rotating body with respect to the axial member;
a stator inside the rotating body; and
one or a plurality of rotor blades provided to the rotating body.

2. The rotating device according to claim 1, wherein at least one end part or a vicinity of the axial member is fixed to the housing.

3. The rotating device according to claim 1 or 2, wherein a stationary blade is provided at an inner surface of the housing, the inner surface opposing an outer surface of the rotating body.

4. The rotating device according to claim 3, wherein the rotor blade and the stationary blade are lined up and arranged at a predetermined interval in the axial direction of the axial member.

5. The rotating device according to claim 1, comprising two bearings including the bearing, wherein
the two bearings are a first bearing and a second bearing,
the first bearing is disposed at one end part side of two end parts of the axial member, and
the second bearing is disposed at the other end part side of the axial member.

6. The rotating device according to claim 5, wherein
in the axial direction of the axial member, a position of the rotor blade and a position of the first bearing at least partially overlap with each other, and
a position of the stationary blade and a position of the second bearing at least partially overlap with each other.

7. The rotating device according to claim 5, wherein, in the axial direction of the axial member, the one or plurality of rotor blades are disposed between the first axial member and the second axial member.

8. The rotating device according to claim 5, wherein a preload in a direction toward one bearing of the first bearing and the second bearing is applied to an inner peripheral ring fixed to the axial member in the other bearing.

9. The rotating device according to claim 1, wherein the one or plurality of rotor blades are disposed in a center part of the rotating body in the axial direction of the axial member.

10. The rotating device according to claim 1, wherein
the rotor blade includes a tubular part and a plurality of blades provided at the tubular part, and
the plurality of blades are provided at the tubular part at predetermined intervals in a circumferential direction of the tubular part.
